(19) United States
(12) Patent Application Publication
(10) Pub. No.: US 2009/0075585 A1
(43) Pub. Date: Mar. 19, 2009

(54) Digital receiver system

(76) Inventor: Itzik KLEIN, Kfar-Monash (IL)

Correspondence Address: EMPK & Shiloh, LLP;c/o Landon IP, Inc., 1700 Diagonal Road, Suite 450, Alexandria, VA, 22314, US

(21) Appl. No.: 12/149,706

(22) Filed: May 7, 2008

Related U.S. Application Data
(60) Provisional application No. 60/973,481, filed on Sep. 19, 2007.

(51) Int. Cl. H04H 40/00

(52) U.S. Cl. 455/3.06

(57) ABSTRACT

A system for receiving wireless digital video transmissions over a WLAN comprising a base station (BS) adapted to provide a conditional access back-channel connection to one or more service providers; and a mobile digital video receiver (DVR) adapted to transmit a request for conditional access to the BS.

### RELATED APPLICATIONS

This application claims the benefit of U.S. Provisional Patent Application No. 60/973,481, filed Sep. 19, 2007, which is incorporated herein by reference.

### FIELD

The disclosure relates to digital broadcasting.

### BACKGROUND

Television sets first became commercially available in the 1930's and have since grown to be a device of major importance for video content delivery. Until the relatively recent introduction of digital television (DTV), television relied largely on the transmission and reception of modulated analog video and audio signals. Originally, the modulated analog signals where transmitted via land-based (terrestrial) transmitters and were received by the television set via an antenna usually incorporated into the television set. Optionally, the antenna was attached to a set-top box (STB) adapted to separate the analog audio signal from the analog video signal, the separated signals then input to the television set. As the technology of “analog” television advanced, land-based transmitters improved their performance and were supplemented by satellite television (SATV) and cable television (CATV). Roof-top antennas and satellite dishes replaced the television antennas incorporated in the television sets. Improved STBs replaced the old STBs, the improved STBs adapted to receive modulated analog signals from SATV and/or CATV, and to convert the received signals to analog video and audio signals for input to the television set.

Introduced in the 1990's, DTV is a communication method comprising transmitting and receiving video and audio in digital format. Typically, the video and audio are digitized and compressed according to a coding scheme which facilitates their transmission in data packets. The packets are then received by receivers adapted to decode the digital signals for subsequent playing out as high quality video content.

DTV generally provides for substantially better video and sound quality compared to analog television. Additionally, as digital channels take up less bandwidth than analog channels, DTV can offer services and facilities not possible with analog television, such as, for example, greater number of channels, multimedia, user interactivity, electronic program guides, selection of spoken languages, selection of subtitle languages, and more.

DTV transmission is generally done through terrestrial networks, satellite networks, cable networks, and/or through the Internet. Traditionally, DTV transmission focused on reception by stationary devices, for example, an HDTV (high definition television) television set adapted for DTV reception and/or an analog television set with an STB adapted to convert the received DTV digital signals into analog video and audio signals. Nevertheless, over the last few years several standards have emerged for mobile DTV (MDTV) transmission to mobile devices, which may also be referred to hereinafter as MDTV devices. The standards for MDTV transmission generally are relevant to wireless reception and to MDTV transmission through terrestrial networks and satellite networks. These standards generally attempt to define and/or describe transmission characteristics which allow optimum reception by mobile devices. Factors typically considered are, for example, rapid movement of the mobile devices and/or low-power consumption in the mobile devices.

The MDTV devices may comprise cellular phones, lap-top computers, personal digital assistants (PDAs), personal navigation equipment, portable media players, portable TVs, and other devices which may be carried by a person or installed in a vehicle such as a car, a boat, and/or an aircraft. The MDTV devices may optionally be adapted to receive terrestrial DTV transmission.

Transmission methods used by MDTV networks and by terrestrial DTV networks may vary within a same region, or from region to region, including from country to country and/or from continent to continent. For example, North American networks generally use ATSC (Advanced Television System Committee) for terrestrial DTV and FLO (Forward Link Only) for MDTV; European networks generally use DVB-T (Digital Video Broadcast—Terrestrial) for terrestrial DTV and DVB-H for MDTV; Japanese networks generally use ISDB-T (Integrated Services Digital Broadcasting—Terrestrial); Chinese networks generally use S-TiMi (Satellite and Terrestrial Interactive Multiservice Infrastructure). The variations in the transmission methods are generally related to the type of modulation used. For example, ATSC transmission methods are based on vestigial sideband (VSB) modulation while DVB-T is based on orthogonal frequency division multiplexing (OFDM). As a result, the DTV receivers in a network within a certain region generally are not adapted to receive DTV transmissions from another network with a different transmission method, whether in the same region or different region.

Despite the variations in the transmission methods, the networks tend to use the same compression format, the MPEG format, to encode and compress the video and audio signals, and to packetize them for transmission in data packets. MPEG is a standard developed by the Motion Pictures Expert Group (MPEG) which comprises encoding and compression methods for digital video content, and transmission formats for the video content. The MPEG is a working group of the ISO/IEC (International Organization for Standardization/International Electrotechnical Commission) established in 1988 and is responsible for the development of video and audio encoding standards. MPEG video compression takes advantage of temporal redundancy and spatial redundancy in video to reduce the number of frames in the video. Temporal redundancy occurs when successive frames of video display images of the same scene. Spatial redundancy occurs due to replication of parts of a picture, usually with minor modifications, within a single frame of video.

The video content, once encoded and compressed, is generally assembled into blocks of video data and separate audio data, each block known as a Packet Elementary Stream (PES). The PES may be of a fixed size, or alternatively, of a variable size. The PES is then broken up into numerous fixed-sized data packets for transmission in an MPEG transport stream (MPEG-TS or TS). Each data packet comprises a Packet Identifier (PID) which serves to identify to the receiver from which PES the packet originates. This allows the transmitter to multiplex several video, audio and data streams, each with a different PID on the same TS. The receiver can then choose the packets with PIDs of its selected video, audio and data streams and reconstruct the content of the correspondent program. The data packets are transmitted unreliably, so that acknowledgement of reception is not returned to the transmitter. Lost data packets or data errors in the received packets are generally corrected at the receiver using forward error correction. Further information on MPEG may be found in “MPEG-2” (www.erg.abdn.ac.uk/research/future-net/digital-video/mpeg2.html) and “MPEG, Standards” (www.chiariglione.org/mpeg/standards.htm), both of which are incorporated herein by reference.

DTV transmissions may also comprise MPEG packets encapsulated in Internet protocol (IP) data packets. IP data packets are used, for example, in DVB-H, which is the DVB European consortium standard for the broadcast transmission of digital handheld television. DVB-H adapts DVB-T system requirements to fit those of handheld, battery-powered receivers. IP data packets are transmitted at high data rates as data bursts in small time slots, the high power-consuming receiving portion of the receiver switching on only for the time interval when the data burst of a selected service is received. The data bursts are stored in a buffer and played out in a TV screen incorporated in the handheld receiver in a live stream, also known as streaming media.

IP datagrams are formatted segments of consecutive data bytes that conform to an internet protocol. IP datagrams may vary in length such that each datagram may have a different number of bytes. In DTV the IP data packets are transmitted unreliably, so that acknowledgement of reception is not returned to the transmitter. Lost data packets or data errors in the received packets are generally corrected at the receiver, using forward error correction.

Reception of DTV, including MDTV, is generally subscriber-based, being that a transmitted content may only be accessed by a user who has been granted access by a service provider. Typically, the service provider, which may be, for example, an entity responsible for transmitting the DTV content, or broadcaster, scrambles and encrypts the contents prior to transmission. The user who has been granted access to the transmitted content, generally is provided with an electronic device which includes appropriate hardware and optional software adapted to descramble and decrypt the transmitted contents. The user who has been granted access to the transmitted content is generally said to have conditional access (CA) to the transmitted contents, and the electronic device is generally referred to as a conditional access module (CAM). The CAM may be comprised in MDTV devices, stationary DTV devices, and optionally in an STB Frequently, the CAM comprises the use of a smart card, the card adapted to be physically inserted into a slot in the CAM, and further adapted to authenticate the subscriber's CA to the transmitted content. Optionally, the smart card may be comprised in the hardware of the of CAM. Optionally, the CAM may comprise a plurality of smart cards.

Often, the subscribers are required to pay for using CA. Usually, in these cases, the MDTV devices, stationary DTV devices, and optional STB, comprise a CAM adapted to support CA as defined by relevant standards for each respective transmission method. Furthermore, the CAM comprises a back-channel connection adapted to enable communication with the service provider for billing purposes, including CA request and authorization; and for CA monitoring. Billing is typically done in one of two manners. A first manner consists in the subscriber purchasing one or more smart cards adapted to allow a subscriber access to all or a number of channels. A second manner consists of the subscriber receiving from the service provider one or more smart cards, and purchasing access to the transmitted content upon request.

A problem occasionally encountered in television is “weak” reception. A major reason is due to interference, which attenuates the signal strength. In case there is major interference in the signal's path from the transmitter to the receiver, the signal that reaches the receiver can be too weak in terms of signal to noise ratio for recognition by the receiver. This phenomenon is especially relevant for reception within buildings when the buildings' walls degrade substantially the signals strength. Other examples of signal strength degradation as a result of interferences are: in cities, where tall buildings between the transmitter and receiver degrades the signal's strength; in open areas, where mountains degrade the signal's strength; and within cars, where the car's exterior degrades the signal's strength. Possible solutions to the problem of weak reception include increasing transmitting power of the transmitters and/or increasing the number of transmitters within a certain area (increase density of transmitters). Drawbacks associated with these solutions may include electromagnetic radiation hazards, energy waste and a substantial increase in the cost of the network.

Another possible solution is based on the use of “small gap fillers”. Small gap fillers are generally small to medium power repeaters which are adapted to receive the weak signal through a receiving antenna, amplify the signal, and retransmit it by means of a transmitting antenna to one or more receivers located within a same house, and/or a same building. More information on small gap fillers is available in “DVB-H Small Gap Fillers Task Force—Technical Requirements & Regulation Issues” dated 4 Jul. 2006, which is incorporated herein by reference.

### SUMMARY

An aspect of some embodiments of the disclosure relates to providing a device, a system and a method for reception of wireless DTV, including MDTV. A device, system, and method for reception of DTV, including MDTV, are described in Provisional Patent Application No. 60/973,482, filed 19 Sep. 2007, which is incorporated herein by reference in its entirety.

According to an aspect of some embodiments of the disclosure, the system comprises a mobile (portable) digital video receiver (DVR), which may also be a plurality of DVRs, adapted to directly receive wireless DTV transmissions from a DTV network, and to receive DTV transmissions through a wire-less local area network (WLAN). Optionally, the DVR is adapted to receive digital multimedia broadcasts (DMB). The DVR may comprise MDTV devices. The WLAN may comprise a wireless network, or any combination of different wireless networks, generally conforming to IEEE Standards 802.11 (Wireless LAN—WiFi). Optionally, the WLAN may conform to IEEE Standards 802.15 (Wireless PAN—WPAN), 802.16 (Broadband Wireless Access—WiMAX), 802.20 (Mobile Broadband Wireless Access—MBWA), and/or 802.22 (Wireless Regional Area Network—WRAN), or any combination thereof. The abovementioned IEEE Standards are all incorporated herein by reference. Optionally, the DVR may be adapted to receive DTV transmissions only through the WLAN.

According to an aspect of some embodiments of the disclosure, the system comprises a Base Station (BS) device adapted to receive wireless DTV transmissions from the DTV network and to convert the wireless DTV transmissions into WLAN content which is transmitted through the WLAN to the DVR. The BS is further adapted to provide the DVR with CA and with back-channel connection capabilities for billing purposes, including CA request and authorization, and for remote monitoring and remote management of the device. The back-channel connection may be through any wired and/or wireless communications network adapted to allow communication between the BS and the service provider, such as, for example, a cellular phone network or the Internet. Using the cellular phone network as back-channel enables the BS to be used in mobile environments such as, for example, planes, automobiles and trains. Optionally, the BS may be adapted to be carried by a user from one location to another. Additionally or alternatively, the BS may also be adapted to be placed in locations wherein in DTV reception and/or WIFI, coverage may be substantially maximized, such as, for example, near a window in a building or a house.

In an embodiment of the disclosure, the DVR may be adapted to negotiate with the BS reception of the WLAN content, and to select between the DTV network and the WLAN the signal with best reception characteristics. Negotiating reception of the WLAN content comprises DVR automatic detection of the BS, and the BS sending network information (DTV transmission method) and program information (DTV frequency and channel) to the DVR responsive to a DVR information request. Additionally, the BS sends signal quality information to the DVR, responsive to a DVR program request for a specific program. This signal quality information may be measured according to the amount of dropped data due to errors received by the BS. The DVR adds to this the amount of dropped data due to errors related to the same program that it receives from the BS, to calculate the total dropped data due to errors for the WLAN connection. The result of this calculation is the signal quality of the WLAN connection. The DTV network signal quality may be measured in the same way, by measuring the amount of dropped data due to errors received by the DTV receiver. The DVR compares WLAN signal quality with DTV network signal quality and selects the network with the better signal quality. Optionally, the DVR is adapted to allow a user of the DVR to select the network regardless of network signal quality. Additionally or alternatively, the DVR compares DTV network signal quality with WLAN signal quality if DTV signal quality is below a predefined threshold value.

The DVR comprises a receiver module for receiving DTV transmissions; a receiver module and transmitter module to communicate back and forth through the WLAN with the BS, a decoder to decode, including decompress, the data received from the DTV transmissions and/or WLAN content, and a controller adapted to negotiate reception of the WLAN content and to manage a substantial portion of DVR functions, including CA functions. Additionally, the controller may be adapted to allow smooth handover when the DVR switches networks.

In an embodiment of the disclosure, the BS comprises one or more receiver modules adapted to simultaneously tune into one or more DTV networks and channels and demodulate wireless DTV transmissions. Further comprised is an encapsulator adapted to encapsulate the received data into WLAN content comprising the IP address or addresses of the destination DVR or DVRs; a WLAN transmitter module and receiver module adapted to transmit the WLAN content and to communicate back and forth with the DVR; and a controller that manages a substantial portion of BS functions.

Additionally comprised in the BS is a CAM adapted to provide the DVR with CA and with back-channel connection to the service provider. The DVR, upon selecting a DTV channel, will transmit a message to the BS indicating the channel selected. The BS, responsive to the message, then connects through the back-channel with the service provider to obtain CA. Once CA is obtained, the BS may proceed to descramble and decrypt the received DTV contents, prior to encapsulating into WLAN content.

Optionally comprised in the BS may be one or more antennas, which may include a window antenna and/or a roof-top antenna, adapted to receive wireless DTV transmissions in one or more spectrum bands, such as VHF, UHF, L-band and S-band. Optionally comprised may be one or more WLAN antennas for DVR transmission and reception.

In another embodiment of the disclosure, DVR reception of DTV transmissions is only through the WLAN. The DVR automatically detects the BS, and responsive to an information request from the DVR, the BS sends network information (DTV transmission method) and program information (DTV frequency and channel) to the DVR. The DVR, upon selecting a DTV channel, will transmit a message to the BS indicating the channel selected. The DVR comprises a WLAN receiver and WLAN transmitter module adapted to communicate back and forth through the WLAN with the BS; a decoder/converter adapted to decode, including decompress, the data received from the WLAN content; and a controller adapted to negotiate reception of the WLAN content and to manage a substantial portion of DVR functions, including CA functions.

There is provided, in accordance with an embodiment of the disclosure, a mobile digital video receiver (DVR) for receiving digital video transmissions comprising a controller adapted to transmit over a wireless local area network (WLAN) a request for conditional access to a selected digital video network channel. The DVR is further adapted to receive digital video transmissions over a WLAN. Optionally, the WLAN is a WiFi (Wireless LAN—WiFi), WPAN (Wireless Personal Area Network), WiMAX (Broadband Wireless Access), MBWA (Mobile Broadband Wireless Access), and/or WRAN (Wireless Regional Access Network), or any combination thereof.

In some embodiments of the disclosure, the DVR is further adapted to receive digital video transmissions directly from a digital video network. Optionally, the digital video transmissions are digital television (DTV) broadcasts. Optionally, the digital video transmissions are digital multimedia broadcasts (DMB).

In some embodiments of the disclosure, the DVR comprises a portable computer (laptop computer). Optionally, the DVR comprises a PDA (personal digital assistant). Optionally, the DVR comprises a cellular phone. Optionally, the DVR comprises a portable media player. Optionally, the DVR comprises portable navigation equipment. Optionally, the DVR comprises a portable television.

In some embodiments of the disclosure, the DVR is further adapted to selectively receive digital video broadcasts through the WLAN or directly from a digital video network. Optionally, the DVR is further adapted to compare signal quality of the digital video network and the WLAN.

There is provided, in accordance with an embodiment of the disclosure, a base station (BS) for retransmitting wireless digital video transmissions over a WLAN comprising a base station unit (BSU) comprising a conditional access module (CAM) adapted to provide a back-channel connection to one or more service providers. Optionally, the WLAN is a WiFi (Wireless LAN—WiFi), WPAN (Wireless Personal Area Network), WiMAX (Broadband Wireless Access), MBWA (Mobile Broadband Wireless Access), and/or WRAN (Wireless Regional Access Network), or any combination thereof. The BS is further adapted to receive wireless digital video transmissions directly from a digital video network. Optionally, the digital video transmissions are wireless digital television (DTV) broadcasts. Optionally, the digital video transmissions are wireless digital multimedia broadcasts (DMB).

In some embodiments of the disclosure, the back-channel connection is through a wired and/or wireless network. Optionally, the back-channel connection is through the Internet. Optionally, the back-channel connection is through a cellular network.

There is provided, in accordance with an embodiment of the disclosure, a system for receiving wireless digital video transmissions over a WLAN comprising a base station (BS) adapted to provide a conditional access back-channel connection to one or more service providers; and a mobile digital video receiver (DVR) adapted to transmit a request for conditional access to the BS.

There is provided, in accordance with an embodiment of the disclosure, a method for receiving wireless digital video transmissions over a WLAN comprising adapting a base station (BS) to connect with one or more service providers via a conditional access back-channel connection; and adapting a mobile digital video receiver (DVR) to transmit a conditional access request to the BS.

### BRIEF DESCRIPTION OF FIGURES

Examples illustrative of embodiments of the disclosure are described below with reference to figures attached hereto. In the figures, identical structures, elements or parts that appear in more than one figure are generally labeled with a same numeral in all the figures in which they appear. Dimensions of components and features shown in the figures are generally chosen for convenience and clarity of presentation and are not necessarily shown to scale. The figures are listed below.

FIG. 1 schematically shows an exemplary functional block diagram of a Digital Video Receiver in accordance with an embodiment of the disclosure;

FIG. 2 schematically shows an exemplary functional block diagram of a Base Station in accordance with an embodiment of the disclosure;

FIG. 3 schematically shows an exemplary functional block diagram of a system for DTV reception in accordance with an embodiment of the disclosure;

FIG. 4 schematically shows a flow diagram of an exemplary method of system operation during DTV reception, in accordance with an embodiment of the disclosure;

FIG. 5 schematically shows an exemplary functional block diagram of a Digital Video Receiver in accordance with another embodiment of the disclosure;

FIG. 6 schematically shows an exemplary functional block diagram of a system for DTV reception in accordance with another embodiment of the disclosure; and

FIG. 7 schematically shows a flow diagram of an exemplary method of system operation during DTV reception, in accordance with another embodiment of the disclosure.

### DETAILED DESCRIPTION

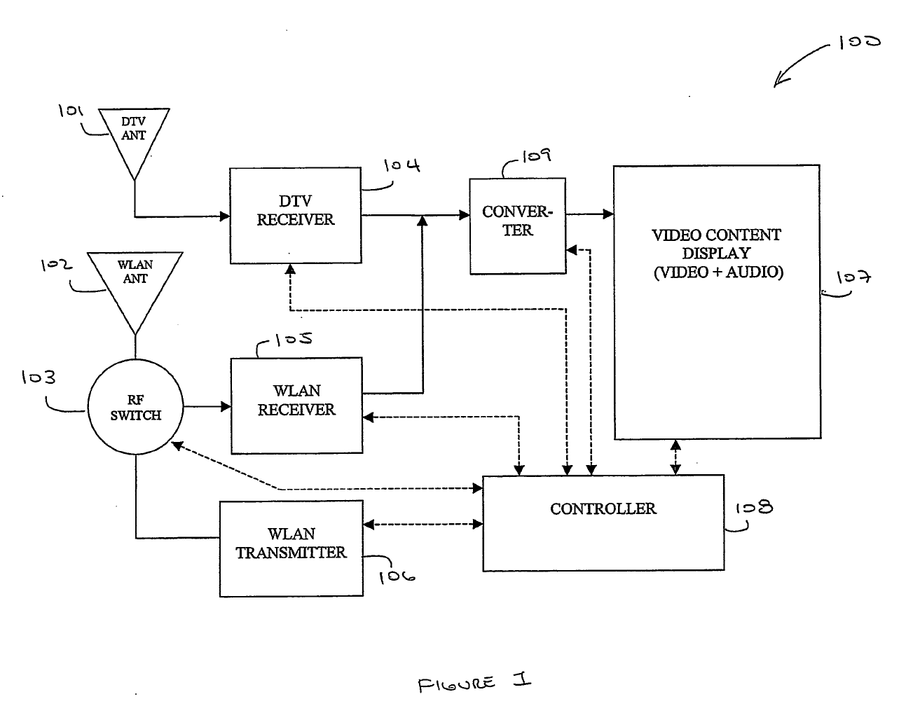

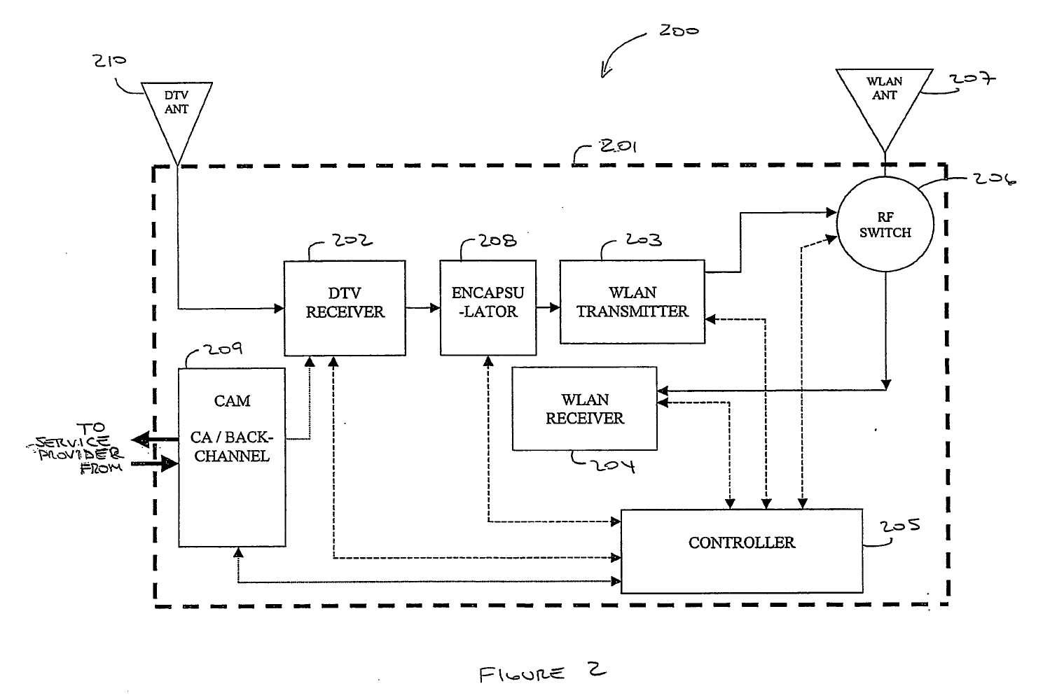

Reference is made to FIG. 1, which schematically shows an exemplary functional block diagram of a mobile (portable) Digital Video Receiver (DVR) 100, in accordance with an embodiment of the disclosure. Reference is also made to FIG. 2 which schematically shows an exemplary functional block diagram of a Base Station (BS) 200, in accordance with an embodiment of the disclosure.

DVR 100 is adapted to receive wireless DTV transmissions through a DTV antenna 101. DTV antenna 101 may comprise one or more antennas configured to receive wireless DTV transmissions from one or more DTV networks in one or more regions where DVR 100 is adapted to operate. For convenience hereinafter, wireless DTV transmissions received through antenna 101 may also be referred to as “received signal”.

The received signal is processed by a DTV receiver module 104 which comprises circuitry adapted to tune into a channel in a network, and demodulate the received signal. Receiver module 104 may demodulate the received signal according to the transmission method used by the DTV network, or networks, in the same region, and/or different regions, where DVR 100 is adapted to operate. For example, if DVR 100 is adapted to receive in Europe where the transmission method for MDTV devices may be DVB-H, and in North America where the transmission method may be FLO, then receiver module 104 is adapted to tune in and demodulate both DVB-H and FLO. Optionally, for example, if DVR 100 is additionally adapted to be used in another region, for example, China, then DTV receiver module 104 is further adapted to tune in and demodulate the received signal corresponding to the transmission method of the region, for example in China, CMMB, in addition to FLO and DVB-H.

DTV receiver module 104 may comprise one or more DTV receiver chips or chipsets, each chip or chipset adapted to process the transmission method of the particular DTV network or networks in which DVR 100 is adapted to operate. Optionally, each chip or chipset may process the transmission methods of more than one network.

Following received signal demodulation by DTV receiver module 104, the received signal is decoded in Decoder/Converter 109, the data decompressed for playing out in a video content display 107. Video content display 107 comprises a screen for viewing the video portion of the received signal and an audio output device for listening to the audio portion of the received signal.

In accordance with an embodiment of the disclosure, DVR 100 is further adapted to receive DTV transmissions as WLAN content in a WLAN. The WLAN may comprise a wireless network, or any combination of different wireless networks, generally conforming to IEEE standards 802.11 (Wireless LAN—WiFi), and may optionally conform to IEEE Standards 802.15 (Wireless PAN—WPAN), 802.16 (Broadband Wireless Access—WiMAX), 802.20 (Mobile Broadband Wireless Access—MBWA), and/or 802.22 (Wireless Regional Area Network—WRAN), or any combination thereof. The mentioned IEEE Standards are all incorporated herein by reference. The WLAN content generally comprises video and audio data from portions of DTV transmissions encapsulated into IP data packets in a Base Station Unit (BSU) 201, comprised in BS 200, and are sent through the WLAN.

DVR 100 is adapted to receive the WLAN content through WLAN antenna 102. WLAN antenna 102 may comprise one or more antennas configured to receive WLAN content from BS 200 and to communicate back and forth with the BS through the WLAN. The WLAN may be for example, WiFi, WPAN, WiMAX, MBWA, and/or WRAN, or any combination thereof. An RF switch 103 controls whether antenna 102 is in a reception mode or transmission mode. In some embodiments of the disclosure the WLAN content may be received by one or more DVR 100 through wireless access point (WAP).

The received WLAN content is processed by a WLAN receiver module 105 which comprises circuitry adapted to demodulate and decode the received WLAN content transmitted through the WLAN. The WLAN may be for example, WiFi, WPAN, WiMAX, MBWA, and/or WRAN, or any combination thereof.

WLAN receiver module 105 may comprise one or more WLAN receiver chips or chipsets, each chip or chipset adapted to process the WLAN content received from each different WLAN, for example WiFi or WiMax. Additionally or alternatively, each chip or chipset may process the WLAN content received from two or more different WLAN.

Following WLAN content processing by WLAN receiver module 105, the WLAN receiver module outputs a signal to Decoder/Converter 109 which is further adapted to decode and decompress the WLAN content for playing out in a video content display 107. Optionally, the output of WLAN receiver 105 may be decoded and decompressed by a decoder different than that used to decode the received signal from DTV receiver module 104. WLAN receiver module 105 is further adapted to receive data from BS 200 comprising WLAN control and/or signaling information, DTV network and/or program information, DTV and WLAN signal quality information, and other information responsive to DVR 100 requests or initiated by the BS.

A controller 108, comprised in DVR 100, is adapted to manage a majority of the functions in DVR 100, including reception and processing of direct DTV transmissions and WLAN content by DTV receiver module 104 and WLAN receiver module 105, respectively. In addition to managing WLAN receiver module 105, controller 108 manages WLAN transmission module 106 which is adapted to send data from controller 108 to BS 200, thereby enabling two-way data communications between DVR 100 and the BS through the WLAN. Controller 108 is further adapted to send BS 200 requests for information regarding DTV network and program availability, and for requesting CA access. Controller 108 is additionally adapted to request information for a particular program related to the amount of dropped data due to errors received by BS 200. Controller 108 adds to this the amount of dropped data due to errors related to a same program received from BS 200, to calculate a total dropped data due to errors for the WLAN connection. Controller 108 is further adapted to compare the total dropped data due to errors for the WLAN connection to an amount of dropped data due to errors of the direct DTV transmission, in order to determine which connectivity has better signal quality. Controller 108 is additionally adapted, responsive to the comparison of the signal qualities, to enable reception through DTV receiver module 104 or WLAN receiver module 105. Controller 108 is further adapted to optionally provide DVR 100 with automatic WLAN detection. In some embodiments of the disclosure a user may override Controller 108 such that the user selects whether to receive direct DTV transmissions or WLAN content.

In some embodiments of the disclosure, controller 108 compares the WLAN signal quality with a predefined threshold. If the signal quality exceeds the threshold, controller 108 may enable reception only through WLAN receiver module 105. Alternatively, in some embodiments of the disclosure, controller 108 compares the direct DTV transmission signal quality with a predefined threshold. If the signal quality exceeds the threshold controller 108 may enable reception only through DTV receiver module 104.

WLAN transmission module 106 may comprise one or more WLAN transmitter chips or chipsets, each chip or chipset adapted to transmit data through the WLAN. Additionally or alternatively, each chip or chipset may transmit the data through two or more different WLAN. In some embodiments of the disclosure the WLAN receiver module 105 and the WLAN transmitter module 106 may be integrated into one or more chips or chipsets.

Referring to FIG. 2, BS 200 comprises the base station unit (BSU) 201, a DTV antenna 210, and a WLAN antenna 207. Optionally, DTV antenna 210 and WLAN antenna 207 may be comprised in BSU 201. BSU 201 is adapted to process wireless DTV transmissions received through DTV antenna 210, and comprises a DTV receiver 202, an encapsulator 208, a WLAN transmitter 203, a WLAN receiver 204, a controller 205, an RF switch 206, and a CAM 209.

DTV antenna 210 may comprise one or more antennas configured to receive the wireless DTV transmissions of a DTV network in a region where BSU 201 is adapted to operate. Optionally, BSU 201 may be adapted to operate in different DTV networks, in a same region, and/or in different regions, in which case antenna 210 may be configured to receive DTV transmissions from the different DTV networks. Antenna 210 may be a window antenna or a roof-top antenna. The roof-top antenna may be a single user antenna, or optionally, a central antenna such as may be used in master antenna TV (MATV) systems. For convenience hereinafter, DTV transmissions received through antenna 210 are referred to as “received signal”, and may be the same or substantially similar to those received by DTV antenna 101 in DVR 100.

The received signal is processed by DTV receiver module 202 which comprises circuitry adapted to substantially simultaneously tune into one or more channels in one or more networks and further adapted to demodulate the received signal or signals. DTV receiver module 202 demodulates the received signal based on the transmission method used by the DTV network or networks in the same region and/or different regions where BS 200 is adapted to operate. For example, if BS 200 is adapted to receive in Europe where the transmission method for MDTV devices may be DVB-H, and in North America where the transmission method may be FLO, then DTV receiver module 202 is adapted to tune in and demodulate both DVB-H and FLO. Optionally, for example, if BS 200 is additionally adapted to be used in another region, for example, China, then DTV receiver module 202 is further adapted to tune in and demodulate the received signal corresponding to the transmission method of the region, for example in China, CMMB, in addition to FLO and DVB-H.

DTV receiver module 202 may comprise one or more DTV receiver chips or chipsets, each chip or chipset adapted to process the transmission method of the particular DTV network or networks in which the BS is adapted to operate. Optionally, each chip or chipset may process the transmission methods of more than one DTV network.

Following received signal demodulation by DTV receiver module 202, received data packets are encapsulated in encapsulator 208 as IP data packets for transmission through a WLAN as WLAN content. Encapsulator 208 is adapted to insert the IP address of destination DVR 100 in the IP data packets. WLAN transmitter 203 comprises circuitry for modulating the data and transmitting the data as WLAN content through the WLAN. WLAN may comprise a wireless network, or any combination of different wireless networks, generally conforming to IEEE Standards 802.11 (Wireless LAN—WiFi), and may optionally conform to IEEE Standards 802.15 (Wireless PAN—WPAN), 802.16 (Broadband Wireless Access—WiMAX), 802.20 (Mobile Broadband Wireless Access—MBWA), and/or 802.22 (Wireless Regional Area Network—WRAN), or any combination thereof.

WLAN transmitter module 203 may comprise one or more WLAN transmitter chips or chipsets, each chip or chipset generally adapted to encode, packetize and/or modulate video and audio data into WLAN content suitable for sending through each different WLAN, for example WiFi or WiMax. Optionally, each chip or chipset may be adapted to encode, packetize and/or modulate video and audio data into WLAN content suitable for sending to two or more different WLAN. WLAN transmitter module 203 is further adapted to transmit data to DVR 100 comprising WLAN control and/or signaling information, DTV network and/or program information, DTV and WLAN signal quality information, and other information responsive to DVR requests or initiated by BS 200.

BSU 201 is adapted to transmit the WLAN content through WLAN antenna 207. WLAN antenna 207 may comprise one or more antennas configured to transmit WLAN content from the BSU and to communicate back and forth with one or more DVR 100 through the WLAN. The WLAN may be for example, WiFi, WPAN, WiMAX, MBWA, and/or WRAN, or any combination thereof. RF switch 206 controls whether antenna 207 is in reception mode or transmission mode. Optionally, RF switch 206 may be comprised in WLAN antenna 207.

In accordance with an embodiment of the disclosure, CAM 209 is adapted to provide DVR 100 with CA to a service provider. Responsive to a message received from DVR 100 upon selection of a DTV channel which requires CA, CAM 209 connects through a back-channel with the service provider to request CA. The back-channel connection may be through any wired and/or wireless communications network adapted to allow 2-way communication between CAM 209 and the service provider, such as, for example, a cellular phone network or the Internet. The back-channel connection may be adapted to be used by the service provider for billing purposes, handling CA requests, transferring authorizations and for remote monitoring and/or remote management of the BS, or any combination thereof. Once CA is obtained, CAM 209, upon receiving authorization from the service provider, is further adapted to assist in descrambling and decrypting the received DTV contents in DTV receiver 202, prior to encapsulation into WLAN content. For example, a smart card comprised in CAM 209 may be reprogrammed with the descrambling/decrypting information for a particular channel.

Controller 205 is adapted to manage a majority of the functions in BSU 201, including tuning and demodulating of direct DTV transmissions by DTV receiver module 202, WLAN content conversion by encapsulator 209, and content transmission by WLAN transmission module 203. Additionally, controller 205 manages WLAN receiver module 204, which is adapted to receive data from DVR 100, thereby enabling two-way data communications between BS 200 and the DVR through the WLAN. Controller 205 sends DVR 100 information regarding DTV network and program availability responsive to DVR information requests. Controller 205 also sends information related to WLAN signal quality for a particular DTV program responsive to DVR program requests. Controller 205 may be further adapted to enable BSU 201 to send detection information for automatic WLAN detection by DVR 100.

Furthermore, in accordance with an embodiment of the disclosure, controller 205 is adapted to manage CAM 209, controlling 2-way communications between CAM 209 and the service provider. Responsive to channel selection by DVR 100, controller 205 processes the selection and sends a message to CAM 209 opening the back-channel. Communications between the service provider and controller 205 may then be established through CAM 209. Controller 205 may be further adapted to process data comprised in the smart card to enable descrambling and decrypting of the received signal in DTV receiver 202.

WLAN receiver module 204 may comprise one or more WLAN receiver chips or chipsets, each chip or chipset adapted to receive data through the WLAN. Additionally or alternatively, each chip or chipset may receive the data from two or more different WLAN. In some embodiments of the disclosure, WLAN receiver module 204 and WLAN transmitter module 203 may be integrated into one or more chips or chipsets.

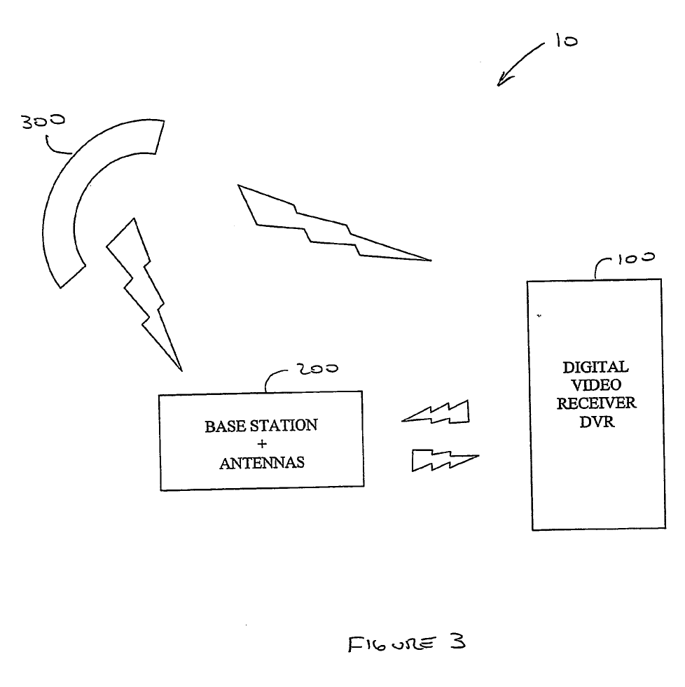

Reference is made to FIG. 3, which schematically shows an exemplary functional block diagram of a system 10 for wireless DTV reception in accordance with an embodiment of the disclosure. System 10 may comprise one or more DVRs, for example DVR 100 shown in FIG. 1, one or more BSs, for example BS 200 shown in FIG. 2, and a DTV transmission network 300.

DTV transmission network 300 may comprise digital terrestrial transmitters and/or digital satellite transmitters. DTV network 300 may have transmission coverage over a same region, which may comprise a circular area defined by a radius, and/or an area defined by boundaries as may be, for example, counties, states, provinces, countries, and/or land masses such as continents. The transmission method used by DTV network 300 may vary within a same region, or from region to region, including from country to country and/or from continent to continent. For example, DTV network 300 in North America may use ATSC while DTV network 300 in Europe may use DVB-T for stationary DTV. Variations in the transmission methods in DVT network 300 may be according to the type of modulation and/or multiplexing used. For example, ATSC transmission may comprise VSB modulation while DVB-T may comprise OFDM. The digital format may comprise MPEG data packets, which may be optionally encapsulated in IP data packets.

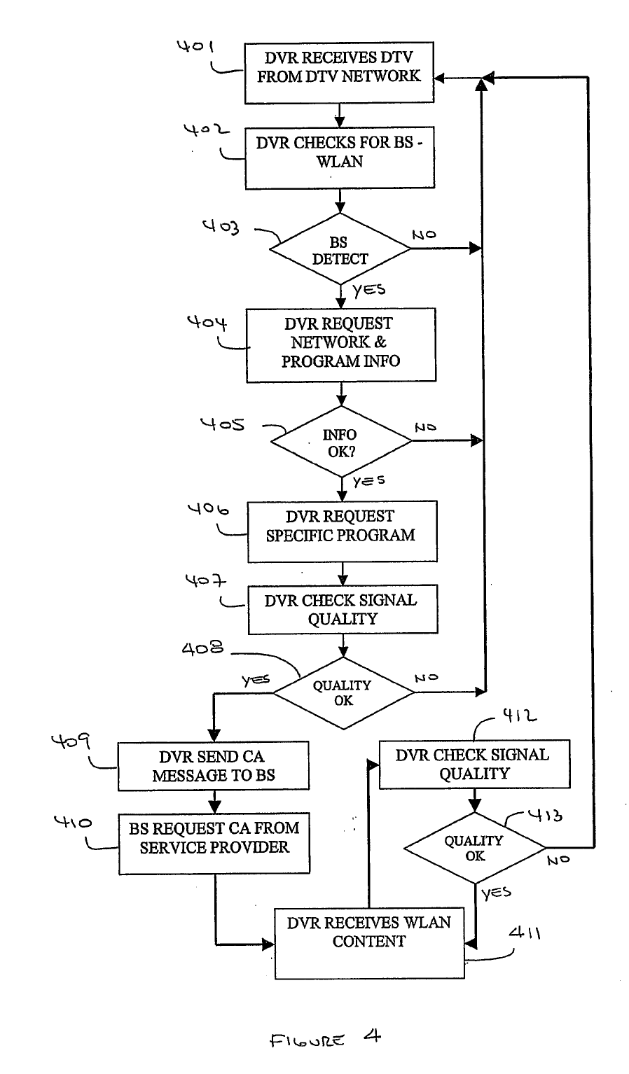

Reference is made to FIG. 4, which schematically shows a flow diagram of an exemplary method of operation of system 10 shown in FIG. 3 during wireless DTV reception, in accordance with an embodiment of the disclosure. Reference is also made to FIGS. 1 and 2. It may be appreciated by a person skilled in the art that the method described herein may be applied in other sequences for the described embodiments, and may be applied in the same sequence described, or in other sequences, to other embodiments of the disclosure.

[STEP 401] In an exemplary scenario DTV transmission network 300 broadcasts programs on different channels and frequencies. DVR 100 receives the broadcasts which are played out on DVR video content display 107 according to a channel selection of a user. BS 200 also receives the broadcasts and registers network and program information.

[STEP 402] DVR 100, which is adapted to receive DTV also through a WLAN, is continuously searching for a BS which is adapted to communicate with the DVR, for example BS 200. The WLAN may be, for example, WiFi, WPAN, WiMAX, MBWA, and/or WRAN, or any combination thereof [STEP 403] Upon detection of BS 200, DVR 100 initiates a “negotiation” process with BS 200 in order to determine whether or not to continue to receive the DTV transmissions directly from DTV network 300. If BS 200 is not detected go to STEP 401. If BS 200 is detected continue to STEP 404.

[STEP 404] Upon detection of BS 200, DVR 100 sends BS 200 a request for network information and a request for program information. BS 200 responds to the request by informing DVR 100 of the network, or networks, and the programs it supports.

[STEP 405] DVR 100 checks if the information received from BS 200 corresponds to the network and programs being received directly from DTV network 300. If no, go to STEP 401. If yes, continue to STEP 406.

[STEP 406] DVR 100 requests a specific program. BSU 201 then tunes DTV receiver module 202 to the requested channel and receives the DTV transmissions associated with the specific program from DTV network 300. BSU 201 converts the DTV transmissions to WLAN content which is transmitted to DVR 100.

[STEP 407] DVR 100 checks the signal quality of the WLAN content received from BS 200 and compares it to the signal quality of DTV network 300.

[STEP 408] If the signal quality of the WLAN content is better than that received directly from DTV network 300 continue to STEP 409. Otherwise, go to STEP 401.

[STEP 409] DVR 100 sends a message to BSU 200 that a channel has been selected through BS 200.

[STEP 410] Controller 205 in BSU 201 processes the channel selection received from DVR 100, and through CAM 209 and the back-channel connection, and sends a request to the service provider for CA. CA is provided by the service provider through the back-channel connection, the smart card in CAM 209 reprogrammed to allow descrambling and decrypting of the received signal. BSU 201 encapsulates the received signal and transmits the WLAN content.

[STEP 411] DVR 100 receives the WLAN content from BS 200.

[STEP 412] DVR 100 continuously or, optionally, periodically according to a predetermined time interval, checks the signal quality of the WLAN content received from BS 200 and compares it to the signal quality of DTV network 300.

[STEP 413] If the signal quality of the WLAN content is better than that received directly from DTV network 300, go to STEP 411. Otherwise, go to STEP 401.

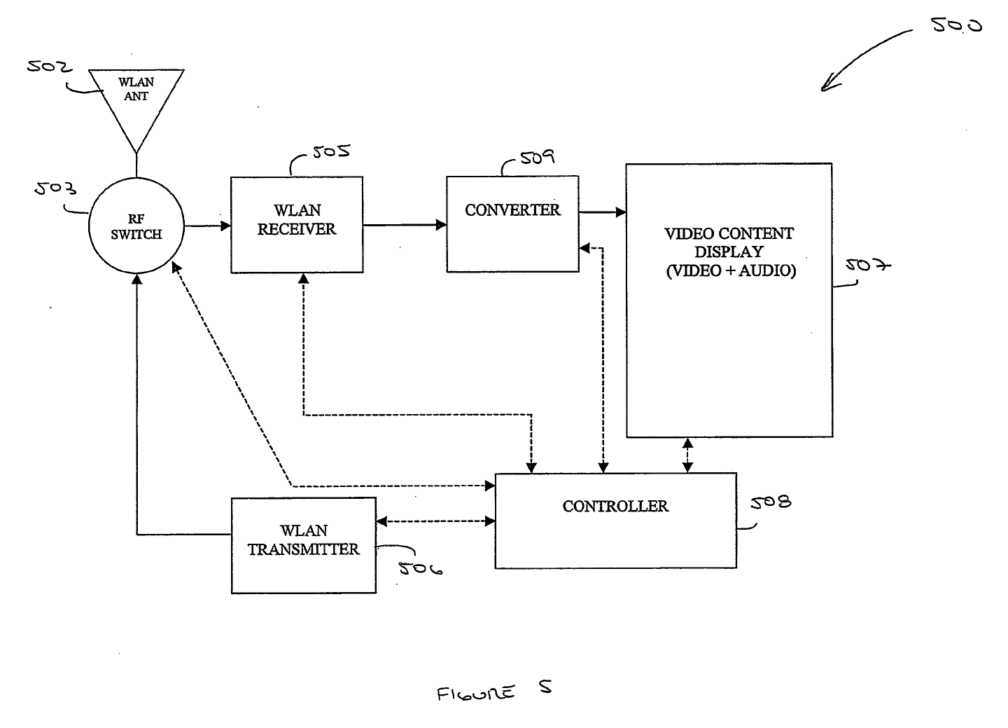

Reference is made to FIG. 5, which schematically shows an exemplary functional block diagram of a mobile Digital Video Receiver (DVR) 500, in accordance with another embodiment of the disclosure. Reference is also made to FIG. 2. DVR 500 is adapted to receive wireless DTV transmissions through a WLAN. DVR 500 may comprise equipment known in the art, including off-the-shelf equipment, adapted to receive WLAN contents, such as, for example, DTV or DMB through the Internet. DVR 500 may comprise mobile devices such as, for example, cellular phones, lap-top computers, personal digital assistants (PDAs), personal navigation equipment, portable media players, portable TVs, and other devices which may be carried by a person or installed in a vehicle such as a car, a train, a boat, and/or an aircraft. DVR 500 may optionally comprise stationary devices.

The WLAN may comprise a wireless network, or any combination of different wireless networks, generally conforming to IEEE Standards 802.11 (Wireless LAN—WiFi), and may optionally conform to IEEE Standards 802.15 (Wireless PAN—WPAN), 802.16 (Broadband Wireless Access—WiMAX), 802.20 (Mobile Broadband Wireless Access—MBWA), and/or 802.22 (Wireless Regional Area Network—WRAN), or any combination thereof. The WLAN content generally comprises video and audio data from portions of DTV transmissions encapsulated into IP data packets in BSU 201 and sent through the WLAN. DVR 500 comprises a WLAN antenna 502; an RF switch 503; a WLAN receiver 505; a decoder/converter 509; a WLAN transmitter 506; a video content display 507; and a controller 508; which may be the same or substantially similar to that shown in FIG. 1 at 100, including 102, 103, 105, 109, 106, 107 and 108, respectively.

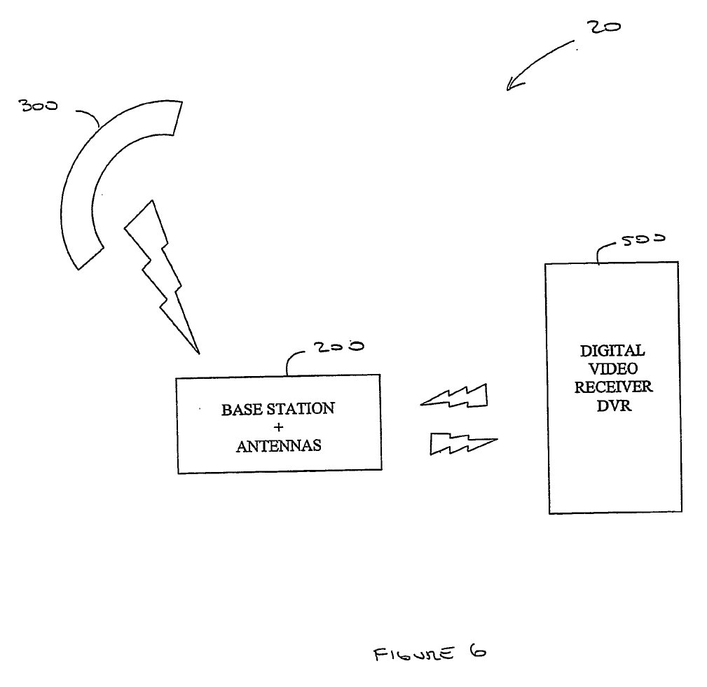

Reference is made to FIG. 6, which schematically shows an exemplary functional block diagram of a system 20 for wireless DTV reception in accordance with another embodiment of the invention. System 20 may comprise one or more DVRs, for example DVR 500 shown in FIG. 5, one or more BSs, for example BS 200 shown in FIG. 2, and a wireless DTV transmission network, such as, for example, network 300 shown in FIG. 3.

DTV transmission network 300 may comprise digital terrestrial transmitters and/or digital satellite transmitters. DTV network 300 may have transmission coverage over a same region, which may comprise a circular area defined by a radius, and/or an area defined by boundaries as may be, for example, counties, states, provinces, countries, and/or land masses such as continents. The transmission method used by DTV network 300 may vary within a same region, or from region to region, including from country to country and/or from continent to continent. For example, DTV network 300 in North America may use ATSC while DTV network 300 in Europe may use DVB-T for stationary DTV. Variations in the transmission methods in DVT network 300 may be according to the type of modulation and/or multiplexing used. For example, ATSC transmission may comprise VSB modulation while DVB-T may comprise OFDM. The digital format may comprise MPEG data packets which may be optionally encapsulated in IP data packets.

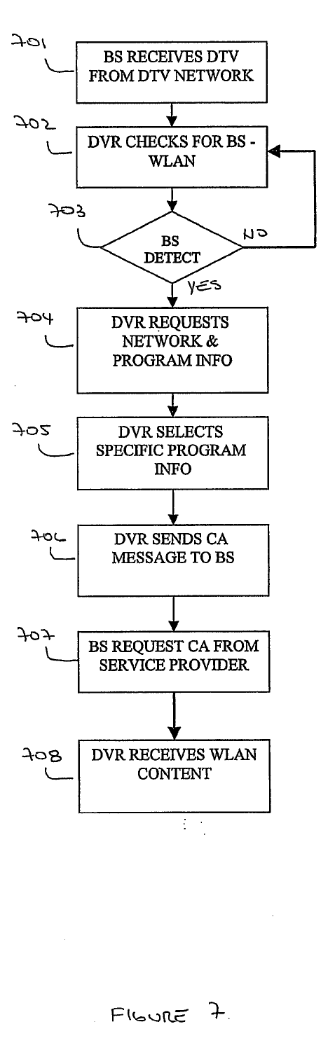

Reference is made to FIG. 7, which schematically shows a flow diagram of an exemplary method of operation of system 20 shown in FIG. 6 during wireless DTV reception, in accordance with another embodiment of the disclosure. Reference is also made to FIGS. 2 and 5. It may be appreciated by a person skilled in the art that the method described herein may be applied in other sequences for the described embodiments, and may be applied in the same sequence described, or in other sequences, to other embodiments of the disclosure.

[STEP 701] In an exemplary scenario, DTV transmission network 300 broadcasts programs on different channels and frequencies. BS 200 receives the broadcasts and registers network and program information.

[STEP 702] DVR 500 is continuously searching through the WLAN for a BS which is adapted to communicate with the DVR, for example BS 200. The WLAN may be, for example, WiFi, WPAN, WiMAX, MBWA, and/or WRAN, or any combination thereof.

[STEP 703] If BS 200 is not detected go to STEP 701. If BS 200 is detected, continue to STEP 704.

[STEP 704] Upon detection of BS 200, DVR 500 sends BS 200 a request for network information and a request for program information. BS 200 responds to the request by informing DVR 500 of the network, or networks, and the programs it supports.

[STEP 705] DVR 500 requests a specific program. BSU 201 then tunes DTV receiver module 202 to the requested channel and receives the DTV transmissions associated with the specific program from DTV network 300. BSU 201 converts the DTV transmissions to WLAN content which is transmitted to DVR 100.

[STEP 706] DVR 500 sends a message to BSU 200 that a channel has been selected.

[STEP 707] Controller 205 in BSU 201 processes the channel selection received from DVR 500, and through CAM 209 and the back-channel connection, sends a request to the service provider for CA. CA is provided by the service provider through the back-channel connection, the smart card in CAM 209 reprogrammed to allow descrambling and decrypting of the received signal. BSU 201 encapsulates the received signal and transmits the WLAN content.

[STEP 708] DVR 500 receives the WLAN content from BS 200.

In the description and claims of embodiments of the present disclosure, each of the words, “comprise” “include” and “have”, and forms thereof, are not necessarily limited to members in a list with which the words may be associated.

The disclosure has been described using various detailed descriptions of embodiments thereof that are provided by way of example and are not intended to limit the scope of the disclosure. The described embodiments may comprise different features, not all of which are required in all embodiments of the disclosure. Some embodiments of the disclosure utilize only some of the features or possible combinations of the features. Variations of embodiments of the disclosure that are described and embodiments of the invention comprising different combinations of features noted in the described embodiments will occur to persons with skill in the art.

1. A mobile digital video receiver (DVR) for receiving digital video transmissions comprising:
a controller adapted to transmit over a wireless local area network (WLAN) a request for conditional access to a selected digital video network channel.

2. The DVR of claim 1 wherein said DVR is further adapted to receive digital video transmissions over a WLAN.

3. The DVR of claim 2, wherein the WLAN is a WiFi (Wireless LAN—WiFi), WPAN (Wireless Personal Area Network), WiMAX (Broadband Wireless Access), MBWA (Mobile Broadband Wireless Access), and/or WRAN (Wireless Regional Access Network), or any combination thereof.

4. The DVR of claim 1 further adapted to receive digital video transmissions directly from a digital video network.

5. The DVR of claim 4 wherein said digital video transmissions are digital television (DTV) broadcasts.

6. The DVR of claim 4 wherein said digital video transmissions are digital multimedia broadcasts (DMB).

7. The DVR of claim 1 wherein said DVR comprises a portable computer (laptop computer).

8. The DVR of claim 1 wherein said DVR comprises a PDA (personal digital assistant).

9. The DVR of claim 1 wherein said DVR comprises a cellular phone.

10. The DVR of claim 1 wherein said DVR comprises a portable media player.

11. The DVR of claim 1 wherein said DVR comprises portable navigation equipment.

12. The DVR of claim 1 wherein said DVR comprises a portable television.

13. The DVR of claim 1 wherein the DVR is further adapted to selectively receive digital video broadcasts through the WLAN or directly from a digital video network.

14. The DVR of claim 13 wherein the DVR is further adapted to compare signal quality of the digital video network and the WLAN.

15. A base station (BS) for retransmitting wireless digital video transmissions over a WLAN comprising:
a base station unit (BSU) comprising a conditional access module (CAM) adapted to provide a back-channel connection to one or more service providers.

16. The BS of claim 15 wherein the WLAN is a WiFi (Wireless LAN—WiFi), WPAN (Wireless Personal Area Network), WiMAX (Broadband Wireless Access), MBWA (Mobile Broadband Wireless Access), and/or WRAN (Wireless Regional Access Network), or any combination thereof.

17. The BS of claim 15 further adapted to receive wireless digital video transmissions directly from a digital video network.

18. The BS of claim 15 wherein said digital video transmissions are wireless digital television (DTV) broadcasts.

19. The BS of claim 15 wherein said digital video transmissions are wireless digital multimedia broadcasts (DMB).

20. The BS of claim 15 wherein the back-channel connection is through a wired and/or wireless network.

21. The BS of claim 20 wherein the back-channel connection is through the Internet.

22. The BS of claim 20 wherein the back-channel connection is through a cellular network.

23. A system for receiving wireless digital video transmissions over a WLAN comprising:
a base station (BS) adapted to provide a conditional access back-channel connection to one or more service providers; and
a mobile digital video receiver (DVR) adapted to transmit a request for conditional access to the BS.

24. A method for receiving wireless digital video transmissions over a WLAN comprising:
adapting a base station (BS) to connect with one or more service providers via a conditional access back-channel connection; and
adapting a mobile digital video receiver (DVR) to transmit a conditional access request to the BS.
